(19) United States
(12) Patent Application Publication
(10) Pub. No.: US 2026/0152583 A1
(43) Pub. Date: Jun. 4, 2026

(54) MODIFIED POLYVINYL POLYMERS AND PACKAGING FOR COMESTIBLES INCLUDING THE POLYMERS

(71) Applicant: H.J. Heinz Company Brands LLC, Pittsburgh, PA (US)

(72) Inventors: Marcus Baumann, Dublin (IE); Kian Donnelly, Dublin (IE); Mara Di Filippo, Dublin (IE)

(21) Appl. No.: 19/125,514

(22) PCT Filed: Nov. 3, 2023
(86) PCT No.: PCT/US2023/078582

§ 371 Date: Apr. 29, 2025

Related U.S. Application Data
(60) Provisional application No. 63/422,801, filed on Nov. 4, 2022.

(51) Int. Cl. C08F 8/14; B32B 27/08; B32B 27/30; B65D 75/26; C08J 5/18

(52) U.S. Cl. CPC C08F 8/14; B32B 27/08; B32B 27/306; B65D 75/26; C08J 5/18; B32B 2250/02; B32B 2250/246; B32B 2307/54; B32B 2307/581; B32B 2307/7163; B32B 2307/7244; B32B 2307/7246; B32B 2439/40; B32B 2439/70; C08F 2810/20; C08J 2329/04

(57) ABSTRACT

A polymeric material is provided that includes a modified polyvinyl polymer having a polyvinyl chain including one or more units having moieties produced by reaction of a reactant with a polyvinyl alcohol. A method of making a modified polyvinyl polymer includes reacting a polyvinyl alcohol with one or more reactants in the presence of a solvent. Packaging includes a polymeric material including a modified polyvinyl polymer.

### CROSS REFERENCE TO RELATED APPLICATION

This application claims the benefit of U.S. Provisional Application No. 63/422,801, filed on Nov. 4, 2022, which is incorporated herein by reference in its entirety.

### FIELD

The present application is directed to polymeric materials, including packaging for comestibles, and methods of manufacture.

### BACKGROUND

Packaging materials are used to contain and protect a variety of items during storage and transport. A variety of materials such as cardboard, plastics, metal, and glass have historically been used for packaging. However, many packaging materials are deposited in a landfill after use. Non-renewable resources such as petroleum have been used to produce conventional plastics. Though plastic-based packaging may be desirable due to its low cost, packaging materials containing such plastics can persist for a considerable period of time in the environment after disposal. Some polymeric films like polyvinyl alcohol (PVOH) may be water soluble. However, it is suspected that PVOH or its derivatives may persist in the environment even after dissolution in water.

Also, some polymeric materials may not provide sufficient mechanical properties, such as tensile strength, puncture strength, water vapor permeability, and oxygen transmission, that are required for specific applications. For example, while water solubility may be viewed as beneficial in terms of utility in some applications, solubility may limit the usefulness of the material as packaging for liquid food products or food products with a high water activity. Also, the pH of a liquid or food product may be detrimental to the stability of the packaging material during the desired shelf life of the product.

### BRIEF DESCRIPTION OF THE DRAWINGS

FIG. 1 illustrates embodiments of reaction schemes for preparing modified polyvinyl polymers;

FIG. 2 illustrates an embodiment of a reaction scheme for preparing modified polyvinyl polymers via reaction between polyvinyl alcohol and succinic anhydride;

FIGS. 3A, 3B, and 3C illustrate various views of an example sachet;

FIG. 4 illustrates example films;

FIGS. 5, 6, 7, and 8 provide IR spectra of example polymeric materials.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Provided herein are modified polyvinyl polymers that can be used for preparing packaging materials. The modified polyvinyl polymers may include structures derived from one or more bio-based components. The modified polyvinyl polymer materials can be formed having varying properties and functional performance for different applications. In one particular approach, polymeric films may be produced from or otherwise include one or more modified polyvinyl polymers and may be used to produce food packaging films, including for aqueous comestibles, such as condiments. In one particular aspect, the food packaging is in the form of a pouch or sachet. Methods of manufacturing the modified polyvinyl polymers, as well as various materials containing the modified polyvinyl polymers, are also provided.

Modified polyvinyl polymers may be provided in the form of films, laminates, and the like. Similarly, modified polyvinyl polymers may be provided in the form of pellets or other granulate forms that may be used to form polymer films, such as in industrial processing and packaging systems. Packaging can include one or more modified polyvinyl polymers and have specially tailored material properties.

Modified polyvinyl polymers can be produced by modifying a polyvinyl polymer such as polyvinyl alcohol to create new moieties on the polyvinyl chain. In some aspects, a modified polyvinyl polymer includes a polyvinyl chain comprising one or more units including an ester moiety produced by reaction of an anhydride reactant with a hydroxyl moiety of a polyvinyl alcohol. In other aspects, a modified polyvinyl polymer includes a polyvinyl chain comprising one or more units including an ether moiety produced by reaction of an epoxide reactant with a hydroxyl moiety of a polyvinyl alcohol.

In one approach, a method of forming modified polyvinyl polymers can include reacting a polyvinyl alcohol with one or more reactants to yield a modified polyvinyl polymer including moieties not present in unmodified polyvinyl alcohol. Such methods can be performed as batch or continuous processes.

In some forms, packaging films can comprise a polymeric material including a structure derived from one or more bio-based components. In some aspects, the packaging optionally includes conventional polymers such as polyethylene, polyethene terephthalate, and polypropylene. Packaging can include one or more modified polyvinyl polymers. A modified polyvinyl polymer can comprise one or more structures derived from one or more bio-based components. A polymer resin for use in making packaging films can include one or more modified polyvinyl polymers and optionally one or more polymers other than a modified polyvinyl polymer. A polymer resin can generally take any form such as pellets, granulate, a film, a sheet, a flexible package, or a container. For example, a sheet or film can be formed by extrusion, wet casting, or melt blowing. In some forms, a film or sheet can be formed from pellets.

A modified polyvinyl polymer can generally include a polyvinyl chain that is derived from any polyvinyl polymer, which can be produced by one or more types of vinyl monomer. For example, a polyvinyl alcohol can be produced by polymerizing vinyl acetate monomers to form polyvinyl acetate. A polyvinyl alcohol can then be formed by hydrolyzing acetate moieties of the polyvinyl acetate into hydroxyl moieties. A polyvinyl alcohol can retain a percentage of acetate moieties when formed through incomplete hydrolysis. For example, various polyvinyl alcohols can have hydrolysis degrees of 50% or more, 60% or more, 70% or more, 75% or more, 80% or more, 85% or more, 90% or more, 91% or more, 92% or more, 93% or more, 94% or more, 95% or more, 96% or more, 97% or more, 98% or more, 99% or more, or hydrolysis degrees ranging from 70% to 100%, 75% to 99%, 80% to 98%, 85% to 97%, 90% to 96%, 91% to 95%, 93% to 95%, or 92% to 94%. Generally, a hydrolysis degree of 100% represents a polyvinyl alcohol where 100% of the acetate moieties of polyvinyl acetate have been hydrolyzed into hydroxyl moieties. It is thought that polyvinyl alcohols having higher degrees of hydrolysis have higher water solubilities due to the increased proportion of hydroxyl groups present when compared to polyvinyl alcohols having relatively lower degrees of hydrolysis. Without intending to be bound by any theory, it is thought that addition of hydroxyl groups via the hydrolysis process increases polarity and thereby the water-solubility of polyvinyl alcohol. In some forms, modified polyvinyl polymer includes a polyvinyl chain produced by modifying a polyvinyl alcohol.

Generally, a modified polyvinyl polymer can include a polyvinyl chain comprising one or more units that increase the lipophilicity of the polyvinyl polymer. Without intending to be bound by any theory, it is thought that modification of hydroxyl moieties of a polyvinyl polymer through reaction with electrophilic molecules can increase local lipophilicity of portions of a polyvinyl chain.

Examples of suitable units that may increase the lipophilicity of the polyvinyl polymer include one or more of a unit comprising an ester moiety, a unit comprising an ether moiety, a unit comprising a carboxylic acid moiety, and a unit comprising an ester moiety and a carboxylic acid moiety. In some aspects, a modified polyvinyl polymer can include units where one or more of a hydroxyl moiety and an acetate moiety of a polyvinyl alcohol have been modified with more or more reactants.

In some aspects, a polyvinyl chain of a modified polyvinyl polymer can comprise one or more units including an ester moiety produced by reaction between an anhydride reactant and a hydroxyl group of a polyvinyl alcohol. An anhydride reactant can generally include any one or more different anhydrides. Suitable anhydrides can be cyclic or non-cyclic. An anhydride reactant can include one or more of an anhydride not including unsaturated carbon-carbon bonds and an anhydride including one or more unsaturated carbon-carbon bonds. An anhydride reactant can include one or more of an anhydride not including a carbon-carbon double bond and an anhydride including one or more carbon-carbon double bonds. In some aspects, a modified polyvinyl polymer includes a polyvinyl chain comprising one or more units including an ester moiety produced by reaction between an anhydride reactant and a hydroxyl group on a polyvinyl alcohol, where the anhydride reactant does not include a carbon-carbon double bond. Examples of anhydrides that can be included in an anhydride reactant include one or more of succinic anhydride, acetic anhydride, propionic anhydride, adipic anhydride, glutaric anhydride, pimelic anhydride, suberic anhydride, malonic anhydride, maleic anhydride, itaconic anhydride, citraconic anhydride, mesaconic anhydride, glutaconic anhydride, and phthalic anhydride.

Succinic anhydride is generally preferred over maleic anhydride. Without intending to be bound by any theory, it is thought that the carbon-carbon double bond in maleic anhydride provides additional reactivity via conjugate additions. This reactivity is in addition to the reactivity between the anhydride and the hydroxyl group that generates an ester moiety. Without intending to be bound by any theory, it is thought that two reaction pathways provided by maleic anhydride could limit control over which reaction pathway dominates by providing less selectivity and making it more difficult to control properties of the product of the reactions.

An anhydride can react with a hydroxyl moiety of a polyvinyl alcohol to form an ester moiety on the polyvinyl chain. In some forms, a polyvinyl chain of a modified polyvinyl polymer can generally have a structure in which at least a fraction of the hydroxyl groups of a polyvinyl alcohol have reacted with an anhydride reactant. In other aspects, a polyvinyl chain can generally have a structure in which all or substantially all hydroxyl groups of a polyvinyl alcohol have reacted with an anhydride reactant.

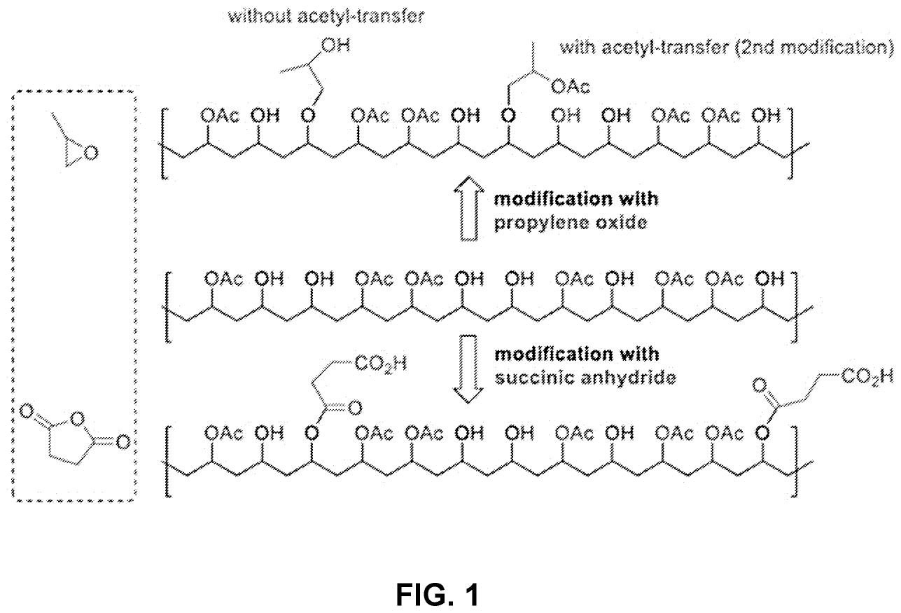

It has been observed that succinic anhydride is a relatively small electrophilic compound and is effective for modifying a polyvinyl alcohol. Also, succinic anhydride can be bio-based and obtained naturally from bio-based or non-petroleum sources. For example, succinic anhydride can be found in shrubs such as Clerodendrum japonicum and Pycnandra acuminata. The reaction depicted by the downward arrow in FIG. 1 shows an embodiment of a reaction between a polyvinyl alcohol and succinic anhydride, which has the following formula (I):

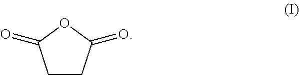

The reaction produces capping units including both ester and carboxylic acid moieties, as shown in the bottom polyvinyl chain in FIG. 1. It is noted that FIG. 1 depicts acetate (acetyl ester) moieties as “OAc” on the polyvinyl chains. Acetate can also be depicted as CH₃COO—.

A modified polyvinyl polymer can generally include a polyvinyl chain comprising one or more units including an ester moiety having the following formula (II):

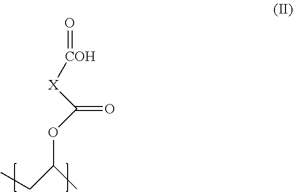

wherein X represents a divalent group. In formula (II), the divalent group X can generally have 2 to 6 carbon atoms. In some aspects, a polyvinyl chain of a modified polyvinyl polymer can comprise one or more units including an ester moiety having the following formula (III):

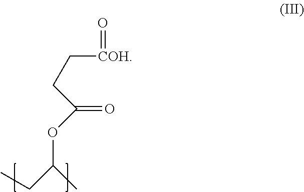

As shown in the formula (III), a unit including an ester moiety can also include a carboxylic acid moiety.

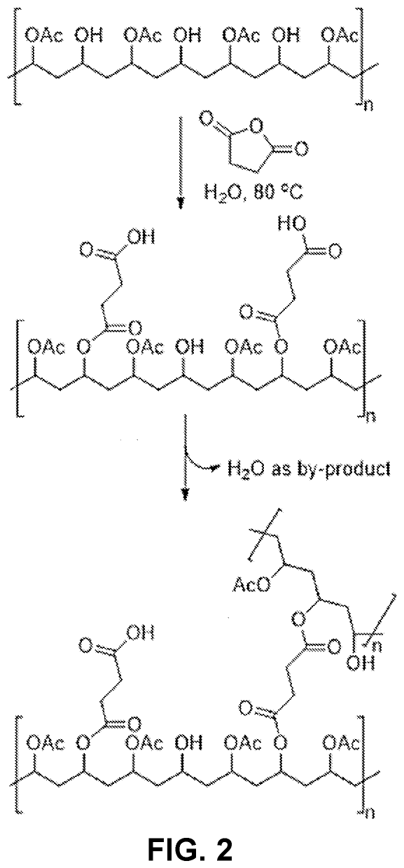

It is also thought that a carboxylic acid moiety formed by reaction of an anhydride reactant with polyvinyl alcohol can react with a hydroxyl group on a polyvinyl chain. By such a reaction, it is thought that crosslinking can occur. For example, FIG. 2 illustrates an embodiment of a reaction between succinic anhydride and a polyvinyl alcohol. As illustrated, succinic anhydride initially reacts with hydroxyl groups of the polyvinyl alcohol to form units including an ester moiety and a carboxylic acid moiety (depicted as an intermediate product in FIG. 2). It is thought that a carboxylic acid moiety can further react with another hydroxyl group to form a crosslink (depicted at the bottom of FIG. 2). It is generally thought that such crosslinking can occur by reaction between a carboxylic acid moiety and a hydroxyl moiety that is on the same polyvinyl chain or between the carboxylic acid and a hydroxyl moiety on a different polyvinyl chain. An ester and water are formed when a carboxylic acid group crosslinks with a hydroxyl group. Without intending to be bound by any theory, it is generally thought that formed ester moieties that add to the stability of the polymer remain on the polyvinyl chain. However, the crosslinking process can be reversed because the ester moiety can be hydrolyzed by water. Therefore, controlling process conditions can determine a degree of crosslinking in a modified polyvinyl polymer. A modified polyvinyl polymer can generally have any degree of crosslinking. In some aspects, modified polyvinyl polymers can have a degree of crosslinking of units including an ester moiety ranging from 70% to 100%, from 80% to 99%, from 90% to 98%, from 91% to 97%, or from 92% to 96%. In FIG. 2, “OAc” represents acetate (acetyl ester) moieties on polyvinyl chains.

In some aspects, a polyvinyl chain of a modified polyvinyl polymer can include one or more crosslink units having the following formula (IV):

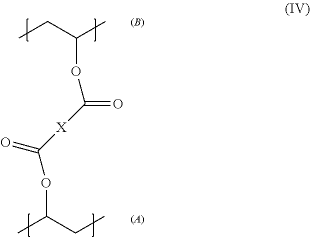

In formula (IV) above, X is a divalent group, and a polyvinyl chain of the modified polyvinyl polymer includes unit (A) indicated with brackets. The divalent group X can generally have 2 to 6 carbon atoms. In some forms, the polyvinyl chain of the modified polyvinyl polymer includes both unit (A) and unit (B) indicated with brackets. In other forms, the polyvinyl chain of the modified polyvinyl polymer includes unit (A), a polyvinyl chain of a separate polymer includes unit (B), and the polyvinyl chain of the separate polymer is derived from polyvinyl alcohol. In some aspects, one of the following conditions is met for a crosslink unit of one or more crosslink units: the polyvinyl chain of the modified polyvinyl polymer includes unit (B), or a polyvinyl chain of a separate polymer includes unit (B), and the polyvinyl chain of the separate polymer is derived from polyvinyl alcohol. In some forms, a modified polyvinyl polymer can include one or more units according to formula (II) and one or more units according to formula (IV).

In some aspects, a polyvinyl chain of a modified polyvinyl polymer can include one or more crosslink units having the following formula (V):

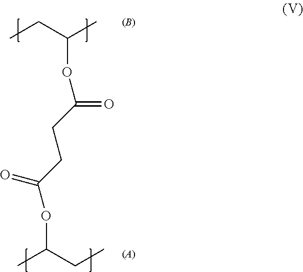

In the formula (V), a polyvinyl chain of the modified polyvinyl polymer includes unit (A) indicated with brackets. In some forms, the polyvinyl chain of the modified polyvinyl polymer includes both unit (A) and unit (B) indicated with brackets. In other forms, the polyvinyl chain of the modified polyvinyl polymer includes unit (A), a polyvinyl chain of a separate polymer includes unit (B), and the polyvinyl chain of the separate polymer is derived from polyvinyl alcohol. In some aspects, one of the following conditions is met for a crosslink unit of one or more crosslink units: the polyvinyl chain of the modified polyvinyl polymer includes unit (B), or a polyvinyl chain of a separate polymer includes unit (B), and the polyvinyl chain of the separate polymer is derived from polyvinyl alcohol. In some forms, a modified polyvinyl polymer can include one or more units according to formula (III) and one or more units according to formula (V).

In some forms, a modified polyvinyl polymer can include a polyvinyl chain comprising one or more units including an ether moiety produced by reaction between an epoxide reactant and a hydroxyl group of a polyvinyl alcohol. A unit including an ether moiety produced by reaction between an epoxide reactant and a hydroxyl group of a polyvinyl alcohol can also include a hydroxyl group. This hydroxyl group can further react with an acetate moiety of a polyvinyl alcohol. It is thought that such a reaction can occur via transesterification between the acetate moiety and the hydroxyl group of the capping group.

An epoxide reactant can generally include one or more of ethylene oxide, propylene oxide, butylene oxide, and styrene epoxide. In one approach, the epoxide reactant has the following formula (VI):

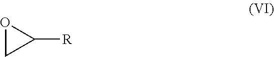

wherein R represents a monovalent group including 0 to 6 carbon atoms. R can generally be aliphatic or aromatic. Propylene oxide is a relatively small electrophilic compound that is effective for modifying a polyvinyl alcohol. In some aspects, a modified polyvinyl polymer includes one or more units including an ether moiety produced by reaction between propylene oxide and a hydroxyl group of a polyvinyl alcohol.

The reaction depicted by the upward arrow in FIG. 1 shows reaction between a hydroxyl group of a polyvinyl alcohol and propylene oxide, which has the following formula (VII):

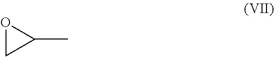

The capping group on the left side of the modified polyvinyl polymer (uppermost polyvinyl chain in FIG. 1) is the product of a first reaction between propylene oxide and a hydroxyl moiety of a polyvinyl alcohol. A modified capping group (annotated as “2^{nd} modification”) at the center of the modified polyvinyl polymer (uppermost polyvinyl chain in FIG. 1) was produced through transesterification between an acetate moiety on the polyvinyl chain and a hydroxyl moiety of a capping group on the same chain. Here, the acetyl moiety has been transferred to the capping group. In some forms, a polyvinyl chain of a modified polyvinyl polymer can generally have a structure in which at least a fraction of the hydroxyl groups of a polyvinyl alcohol have reacted with an epoxide reactant. In some aspects, a polyvinyl chain of a modified polyvinyl polymer can have a structure in which all or substantially all hydroxyl groups of the polyvinyl alcohol polymer have reacted with the epoxide reactant to form the units including an ether moiety. In some forms, a polyvinyl chain of a modified polyvinyl polymer can have a structure in which at least a fraction of units including an ether moiety (capping group formed by reaction between an epoxide reactant and a hydroxyl moiety) are further reacted by transfer of an acetyl moiety from a polyvinyl chain to the capping group. In some aspects, a polyvinyl chain of a modified polyvinyl polymer can have a structure in which all or substantially units including an ether moiety (capping group formed by reaction between an epoxide reactant and a hydroxyl moiety) are further reacted by transfer of an acetyl moiety from a polyvinyl chain to the capping group.

A modified polyvinyl polymer can include a polyvinyl chain comprising one or more units selected from a unit including an ester moiety produced by reaction between an anhydride reactant and a hydroxyl group of a polyvinyl alcohol, and a unit including an ether moiety produced by reaction between an epoxide reactant and a hydroxyl group of a polyvinyl alcohol. In some forms, a modified polyvinyl polymer can include a polyvinyl chain comprising one or more units including an ester moiety produced by reaction between an acid halide (e.g., acid chloride) and a hydroxyl group of a polyvinyl alcohol.

Generally, a modified polyvinyl polymer can include a polyvinyl chain comprising one or more vinyl alcohol units of the following formula (VIII):

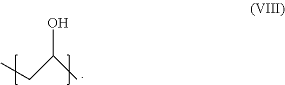

A polyvinyl chain of a modified polyvinyl polymer can comprise one or more vinyl acetate units of the following formula (IX):

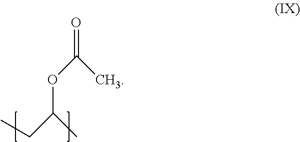

In some aspects, a polyvinyl chain of a modified polyvinyl polymer can comprise any one or more selected from a unit including an ester moiety selected from formulas (II), (III), (IV), (V), a unit including an ether moiety derived from monomers selected from formulas (VI) and (VII), and optionally one or more units selected from formulas (VIII) and (IX). In some forms, a polyvinyl chain of a modified polyvinyl polymer can comprise any one or more selected from a unit including an ester moiety selected from formulas (II), (III), (IV), (V), and optionally one or more units of selected from formulas (VIII) and (IX).

The modified polyvinyl polymer may be provided with a range of possible properties and performance. In some aspects, the modified polyvinyl polymer may have a weight-average molecular weight (Mw) of about 15,000 g/mol to about 200,000 g/mol, about 60,000 g/mol to about 160,000 g/mol, about 90,000 g/mol to about 125,000 g/mol, or about 100,000 g/mol to about 115,000 g/mol. In some aspects, the modified polyvinyl polymer may have a number-average molecular weight (Mn) of about 500 g/mol to about 90,000 g/mol, about 1000 g/mol to about 80,000 g/mol, about 2000 g/mol to about 70,000 g/mol, about 15,000 g/mol to about 60,000 g/mol, about 30,000 g/mol to about 45,000 g/mol, or about 35,000 g/mol to about 40,000 g/mol. In some forms, the modified polyvinyl polymer may have polydispersity index (Mw/Mn) of about 2.0 to about 27.0, about 2.0 to about 8.0, about 2.0 to about 4.0, about 2.5 to about 3.5, or about 2.75 to about 2.95. The foregoing molecular weights and polydispersity can be determined using gel permeation chromatography (GPC).

Generally, a method of making a modified polyvinyl polymer can include reacting a polyvinyl alcohol having a hydrolysis degree of at least 50% with one or more of an anhydride and an epoxide reactant. In some aspects, polyvinyl alcohol can be dissolved in a first solvent to prepare a first solution and one or more reactants can be dissolved in a second solvent to prepare a second solution, and the first and second solutions can be combined to carry out the reaction. In other aspects, a single solvent can be used for dissolving polyvinyl alcohol and reactants can be added to the solution of polyvinyl alcohol to perform the reaction.

Examples of solvents that can be used in a method of making a modified polyvinyl polymer include water, acetonitrile, and mixtures thereof. In some aspects, polyvinyl alcohol is dissolved in water and one or more of an anhydride reactant and an epoxide reactant are dissolved in acetonitrile, and then the two solutions are combined to perform the reaction. In other aspects, polyvinyl alcohol is dissolved in water and then one or more reactants is added to the aqueous solution including the polyvinyl alcohol to conduct the reaction.

Any useful mass or molar ratio of one or more reactants to polyvinyl alcohol can be utilized in a method of making a modified polyvinyl polymer. In one approach, a mass ratio of one or more of an anhydride reactant and a epoxide reactant to polyvinyl alcohol ranges from 0.01:1 to 0.5:1, in another aspect a mass ratio of 0.05:1 to 0.4:1, in another aspect a mass ratio of 0.06:1 to 0.3:1, and in yet another approach a mass ratio of 0.1:1 to 0.15:1.

A method of making a modified polyvinyl polymer can generally be performed on a batch or a continuous basis. A batch process can include placing all reactants in a reaction vessel and conducting the reaction until completion. A continuous process can be carried out for long periods of time and continuously produce reaction products as reactants are fed to the process and reaction conditions are maintained. In some forms, a method of making a modified polyvinyl polymer is conducted in a flow reactor comprising a passageway through which polyvinyl alcohol and one or more reactants flow and react. A solution including polyvinyl alcohol can pumped through a flow reactor at a particular rate and concentration and another solution including one or more reactants such as an anhydride and/or an epoxide can be pumped through the reactor at a particular rate and concentration. The chemical structure, composition and properties of a product exiting the flow reactor can be tuned by adjusting concentrations and flow rates of separate solutions.

Generally, a method of making a modified polyvinyl polymer can be carried out at any useful reaction temperature. In some forms, a method of making a modified polyvinyl polymer includes reacting a polyvinyl alcohol with or more reactants at a temperature ranging from about 60° C. to about 90° C., about 70° C. to about 80° C., about 75° C. to about 95° C., about 80° C. to about 90° C., or about 82° C. to about 88° C.

The method may further include inducing crosslinking of the modified polyvinyl polymers. Without intending to be bound by any theory, it is thought that the degree of crosslinking allows the material stiffness and strength to be modified, as well as the water solubility of the material.

In some aspects, a polymeric film including a modified polyvinyl polymer has a tensile strength and elongation sufficient to suitably package a comestible product. In one aspect, a polymeric film including the modified polyvinyl polymer has a tensile strength of greater than about 50 N according to ASTM D882. In some forms, a polymeric film including the modified polyvinyl polymer has a tensile strength ranging from about 50 N to about 200N, about 60 N to about 150 N, or about 70 N to about 100 N.

In yet another aspect, a polymeric film including a modified polyvinyl polymer has a puncture strength sufficient to suitably package an item. In one aspect, a polymeric film including the modified polyvinyl polymer has a puncture strength of greater than about 20 N according to ASTM F1306. In some forms, a polymeric film including the modified polyvinyl polymer has a puncture strength ranging from about 50 N to about 110 N, about 70 N to about 100 N, or about 80 N to about 90 N.

As noted above, the modified polyvinyl polymers provided herein can be used to prepare films, such as may be used for a package or packaging. Generally, packaging can enclose or otherwise contain any type of product. In some aspects, packaging including a modified polyvinyl polymer can contain food such as condiments (e.g., ketchup, mayonnaise, mustard, relish, ponzu sauce, oil, vinegar, tartar sauce, fry sauce, and soy sauce), salad dressing, cheese, vegetables, soup, or meat. Examples of food packaging include pouches, sachets, and thermoformed containers. In other forms, packaging can be formed by heat or mechanically sealing one or more films.

Without intending to be bound by any particular theory, it is thought that some forms of modified polyvinyl polymers having relatively higher numbers of moieties derived from succinic anhydride exhibit higher levels of water resistance when compared with modified polyvinyl polymers having relatively fewer moieties derived from succinic anhydride. Without intending to be bound by any theory, it is thought that modified polyvinyl polymers having a high number of residual hydroxyl groups unmodified with an anhydride reactant serve to increase the water solubility of the polymer, while a modified polyvinyl polymer having fewer relatively hydroxyl groups will be relatively less soluble. Thus, it is contemplated that solubility of modified polyvinyl polymers can be tailored by relatively increasing or decreasing the degree of modification with anhydride reactant.

In some forms, a polymeric film can generally include one or more modified polyvinyl polymers. In some aspects, packaging can generally include one or more modified polyvinyl polymers or one or more polymeric films including one or more modified polyvinyl polymers and optionally additional polymers or polymeric films not including a modified polyvinyl polymer. Packaging comprising a modified polyvinyl polymer can generally contain products having any combination of properties.

In some approaches, a food sachet can comprise a sachet body including a film comprising a modified polyvinyl polymer. A food product can be enclosed in the sachet body. In some aspects, a condiment is enclosed in a sachet body.

The packaging film may include one or more additional layers to provide desired properties to the overall packaging film. For example, the one or more additional layers may be included to provide desired tensile strength, puncture strength, water vapor permeability, and/or oxygen transmission values.

In one approach, the packaging has a structure and composition that is compatible with the packaged item to provide a desired shelf life. In various aspects, this compatibility can avoid or reduce premature degradation and mechanical weakness of packaging material contacting a packaged item, prevent or reduce leaching of materials from the packaging and into contact with a packaged item, or prevent or reduce loss of moisture from a packaged material through the packaging.

In some aspects, packaging can comprise a polymeric film including one or more modified polyvinyl polymers, where one or more of the packaging and the polymer has one or properties (e.g., chemical composition and mechanical properties) tailored for contact with a particular packaged item.

Packaging made with the modified polyvinyl polymer can include a single layer of film or, in another aspect, two or more layers of film. Similarly, the modified polyvinyl polymer may be layered with other materials such that the modified polyvinyl polymer may be an inner layer, an outer layer, and/or an intermediate layer. Further, multiple layers of the modified polyvinyl polymer material may be used by itself or in combination with other layers. Examples of other layers include, but are not limited to, ethylcellulose, soy protein, and other biopolymers.

In some aspects, packaging can enclose or otherwise contain a product having a moisture content of ranging from about 1 wt. % to about 99 wt. %, about 5 wt. % to about 95 wt. %, about 10 wt. % to about 90 wt. %, about 20 wt. % to about 80 wt. %, about 30 wt. % to about 70 wt. %, about 40 wt. % to about 60 wt. %, or about 45 wt. % to about 55 wt. %. In some forms, a sachet comprises a modified polyvinyl polymer and encloses a condiment, such as ketchup, having a moisture content ranging from about 60 wt. % to about 70 wt. %, in another aspect about 63 wt. % to about 70 wt. %.

Packaging can comprise a modified polyvinyl polymer and enclose a product having any water activity (aw). In some aspects, packaging can enclose or otherwise contain a product having aw ranging from about 0.05 to about 0.99, about 0.1 to about 0.98, about 0.2 to about 0.9, about 0.3 to about 0.8, about 0.4 to about 0.7, or about 0.5 to about 0.6. In some forms, a sachet comprises a modified polyvinyl polymer and encloses ketchup having aw ranging from about 0.91 to about 0.98, about 0.92 to about 0.97, about 0.93 to about 0.96, or about 0.94 to about 0.95.

Packaging can comprise a modified polyvinyl polymer and enclose a product having any degree of brix (° Bx). In some aspects, packaging can enclose or otherwise contain a product having a degree of brix ranging from about 0.5° Bx to about 95° Bx, about 1° Bx to about 90° Bx, about 5° Bx to about 85° Bx, about 10° Bx to about 80° Bx, about 20° Bx to about 70° Bx, about 30° Bx to about 60° Bx, or about 40° Bx to about 50° Bx. In some forms, a sachet comprises a modified polyvinyl polymer and encloses ketchup having degree of brix ranging from about 30° Bx to about 40° Bx, about 31° Bx to about 39° Bx, about 32° Bx to about 38° Bx, about 33° Bx to about 37° Bx, or about 34° Bx to about 36° Bx.

Packaging can comprise a modified polyvinyl polymer as provided herein and enclose a product that has a generally basic, acidic or neutral pH. In some aspects, packaging can enclose or otherwise contain a product having a pH of about 3 to about 9, about 4 to about 8, about 4.5 to about 5, about 6 to about 7, about 3.5 to about 7.5, about 4 to about 7, about 4.5 to about 6.5, or about 5 to about 6. In some forms, a sachet comprises a modified polyvinyl polymer and encloses ketchup having pH ranging from about 3 to about 4.5, about 3 to about 4, about 3.1 to about 3.9, about 3.8 to about 3.99, or a pH of less than about 4.

In one particular approach, ketchup having a pH ranging from about 3.2 to about 4.0 is enclosed in a sachet body.

In one approach, a hydrophilic layer may be used as an interior layer for a food packaging film, while an outer layer may have a different composition that allows for faster degradation upon contact with water and/or soil.

Coatings may also be used to modify the properties and function of the modified polyvinyl polymer material, especially when used as packaging for comestibles. Such coatings include, but are not limited to, waxes, such as beeswax, and other biopolymers.

In one approach, a package includes a first film comprising a modified polyvinyl polymer having properties suitable for food contact and a second film including an unmodified polyvinyl alcohol polymer susceptible to rapid dissolution upon contact with moisture. Examples of unmodified polyvinyl alcohol polymers include those described herein having any degree of hydrolysis but without further capping or modification of hydroxyl and acetate moieties. In some forms, a multilayered package comprises an inner film comprising modified polyvinyl polymer directly in contact with a packaged product, and an outer film comprising unmodified polyvinyl alcohol polymer not directly exposed to the product. In other forms, a multilayered package comprises an inner film comprising unmodified polyvinyl alcohol directly in contact with a packaged product and an outer film comprising a modified polyvinyl polymer not directly exposed to the product.

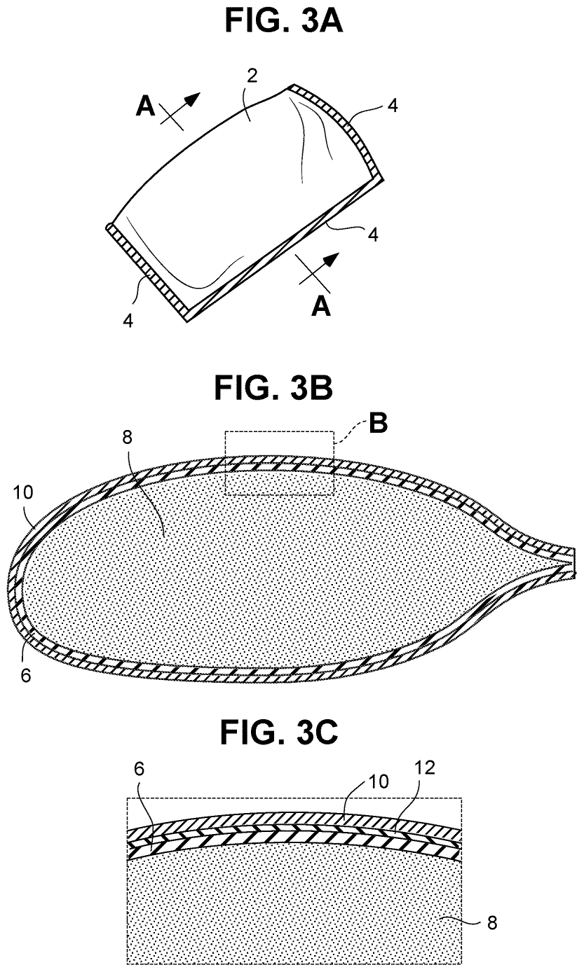

FIG. 3A illustrates an embodiment of a food sachet comprising a sachet body 2 having seals 4 on three sides. The sachet was formed by folding a film and sealing three of the sides. FIG. 3B illustrates a cross-section of the food sachet in FIG. 3A taken along line A-A. In FIG. 3B, a first film 6 comprises a modified polyvinyl polymer and contacts a comestible item 8 (e.g., ketchup) disposed inside the sachet body. A second film 10 includes an unmodified polyvinyl alcohol polymer and forms an exterior of the sachet body. While the illustrated sachet has seals on three sides, it is understood that other numbers of seals could be used, such as two seals, four seals, etc.

FIG. 3C illustrates an enlarged portion of the cross section of the embodiment of the food sachet shown in FIG. 3B, taken at box B.

Various examples were prepared and tested to compare the impact of starting materials, method of manufacture and other variables associated with the materials.

### EXAMPLES

The following examples are provided to illustrate various embodiments without any limiting effect.

### Example 1—Modified Polyvinyl Polymer Including Units Produced by Reaction Between Succinic Anhydride and Hydroxyl Groups of a Polyvinyl Alcohol

A polyvinyl alcohol solution was prepared by dissolving 1.0 gram of granular PVOH-418 (a warm water soluble polyvinyl alcohol having 92% degree of hydrolysis from Aquapak Polymers Ltd., Birmingham, UK) in 10 mL of water. An anhydride solution was prepared by dissolving 0.5 g succinic anhydride (sold by Merck/Sigma Aldrich) in 5 mL of acetonitrile.

A flow reactor assembly that included peristaltic pumps was used to deliver the polyvinyl alcohol solution and the anhydride solution to a T-mixer. The T-mixer turbulently mixed the solutions into a homogenous reaction mixture, which was then fed to the reactor. The reactor included two reactor cores constructed of PFA (perfluoroalkoxy alkanes) tubing coils. A reactor control unit controlled the temperature and residence time of the reaction mixture within the reactor cores. A total reaction time (residence time) of the reaction mixture through both reactor cores was 10-30 min at temperatures of 60-70° C. The reaction mixture remained homogeneous throughout the residence time without fouling or blocking the reactor tubing. A product collection vial collected polymeric material that exited the flow reactor assembly. The collected product was poured into a petri dish and dried by slow evaporation at 40° C. for 1 to 2 days. The resulting film can be used in packaging material.

### Example 2—Modified Polyvinyl Polymer Including Units Produced by Reaction Between Propylene Oxide and Hydroxyl Groups of a Polyvinyl Alcohol (“POxide” Film)

A polyvinyl alcohol solution was prepared by dissolving 1.0 gram of PVOH-418 (a warm water soluble polyvinyl alcohol having 92% degree of hydrolysis from Aquapak Polymers Ltd., Birmingham, UK) in 10 mL of water. An epoxide solution was prepared by mixing 0.5 mL of propylene oxide with 5 mL of acetonitrile. The polyvinyl alcohol solution and the epoxide solution were fed to the reactor assembly described in Example 1 and subjected to the same reaction conditions and drying procedure used in Example 1.

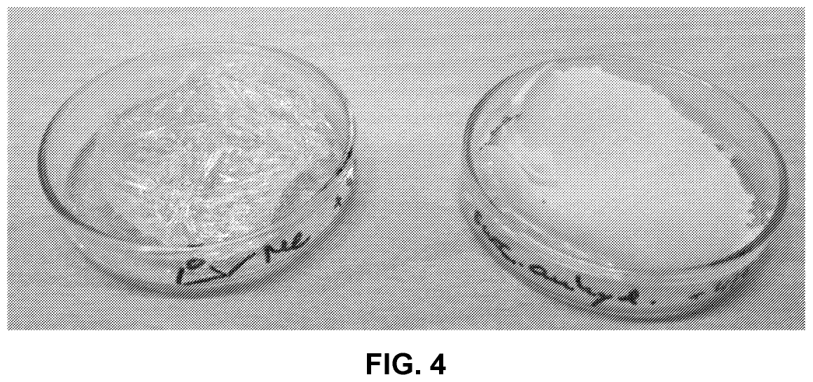

FIG. 4 shows two petri dishes. The left dish includes the product of Example 2, which had a gel-like, clear and colorless appearance. The right dish includes the product of Example 1 having an opaque and rubber-like appearance. Both modified polymers provided flexible films and were fully soluble in water at 40° C. The resulting film can be used in packaging material.

### IR Testing

Infrared spectroscopy (IR) was used to evaluate differences in vibrational frequencies associated with the acetate moiety in the unmodified polyvinyl alcohol (PVOH-418) versus the two modified polyvinyl polymers of Examples 1 and 2. The IR spectroscopy also evaluated appearance of vibrations associated with units produced by reaction succinic anhydride in Example 1 and produced by reaction of propylene oxide in Example 2. IR spectra were obtained using a Bruker Platinum spectrometer (neat, ATR sampling).

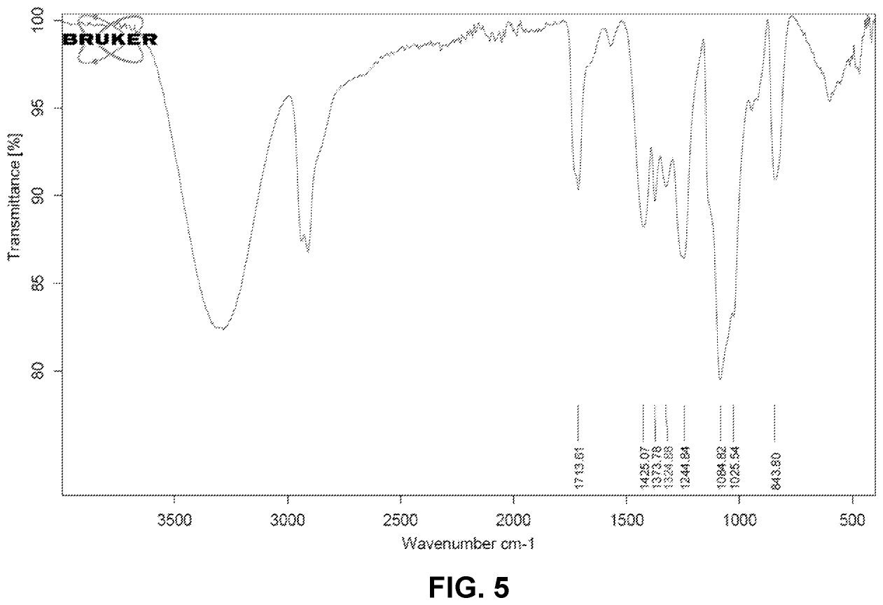

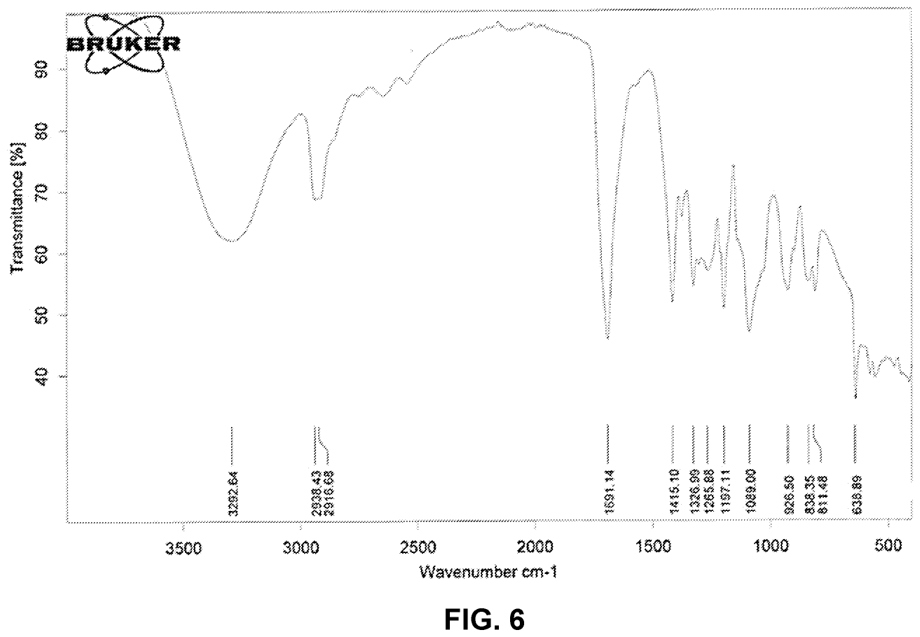

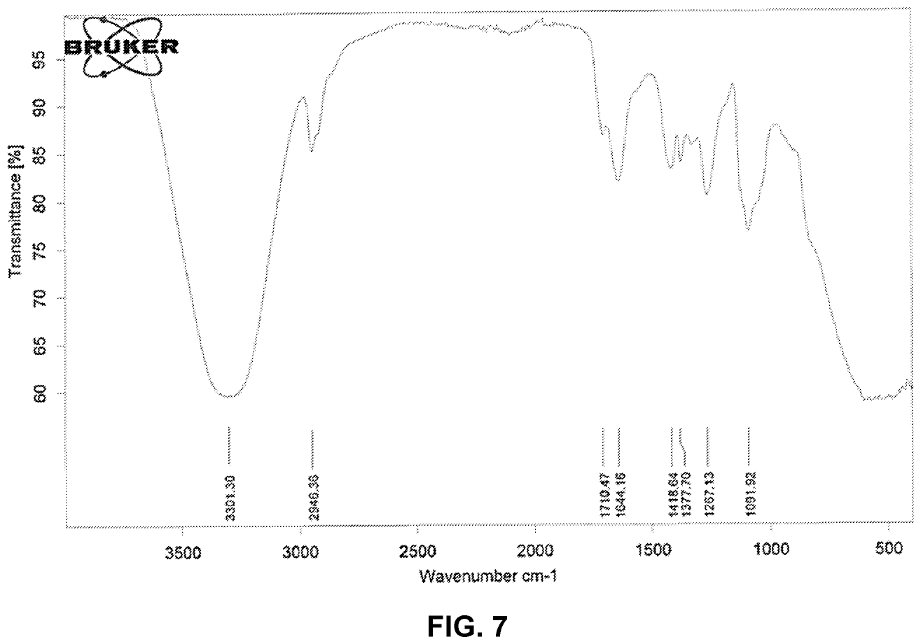

FIG. 5 is the IR spectrum for the unmodified PVOH-418, FIG. 6 is the IR spectrum for Example 1, and FIG. 7 is the IR spectrum for Example 2. When compared with band at 1714 cm-1 in FIG. 5, the spectrum in FIG. 6 shows an intense band at 1691 cm-1 associated with the structure resulting from modification with succinic anhydride. When compared with FIG. 5, the spectrum in FIG. 7 shows an additional broad band at 1644 cm-1 associated with the modification by propylene oxide.

### Example 3—Modified Polyvinyl Polymer Including Units Produced by Reaction Between Succinic Anhydride and Hydroxyl Groups of a Polyvinyl Alcohol

### Suc1 Film

A polyvinyl alcohol solution was prepared by dissolving/suspending 30 g of PVOH-418 in 300 mL deionized water. The solution was placed in 500 mL Schott glass bottle including a 2 cm magnetic stir bar, which rested on an IKA hotplate with magnetic stirring. Next, 4 grams of solid succinic anhydride was added to the polyvinyl alcohol solution and the mixture was vigorously stirred at 80° C. for 5 hours. The reaction mixture was initially cloudy but produced a clear solution within 1 hour.

The modified polyvinyl polymer was poured without prior cooling into four 40×20 cm plastic storage boxes, aiming for about 70 grams of the product per box. After two days of dry evaporation in a fume hood in the absence of light, films were peeled from the boxes and stored between paper to avoid curling.

### Suc2 Film

The same procedure was carried out as in Example “Suc1” above, with the exception that 2 g (instead of 4 g) of solid succinic anhydride was added to the polyvinyl alcohol solution. Sample films were obtained.

### Suc3 Film

The same procedure was carried out as in Example “Suc1” above, with the exception that 6 g of solid succinic anhydride was added to the polyvinyl alcohol solution. Sample films were obtained.

### POxide Film

The same procedure was carried out as in Example 2 above using propylene oxide. Sample films were obtained. Limited tests were carried out on the propylene oxide (“POxide”) film.

The dried films of the Suc1, Suc2, Suc3, and POxide samples were peeled from the casting boxes. At the time of peeling, these films were usually fully transparent but developed a slightly opaque appearance within a few days, which may indicate further drying. After peeling, the films continued to dry and were without any sticky quality.

The samples Suc1, Suc2, Suc3, and POxide were compared to conventional polyvinyl alcohol products: a hot water soluble PVOH (“HWS PVOH”; sold by Aquapak as 30164P); and a warm water soluble PVOH (“WWS PVOH”; sold by Aquapak as 33104P). The average gauge of the films of Examples Suc1, Suc2, Suc3, POxide, HWS PVOH, and WWS PVOH are shown in Table 1.

TABLE 1

| Sample | Average gauge of films (μm) |
|---|---|
| Suc1 | 141 |
| Suc2 | 42 |
| Suc3 | 95 |
| POxide | 52 |
| HWS PVOH (comparative) | 25 |
| WWS PVOH (comparative) | 25 |

### Testing

### IR Testing

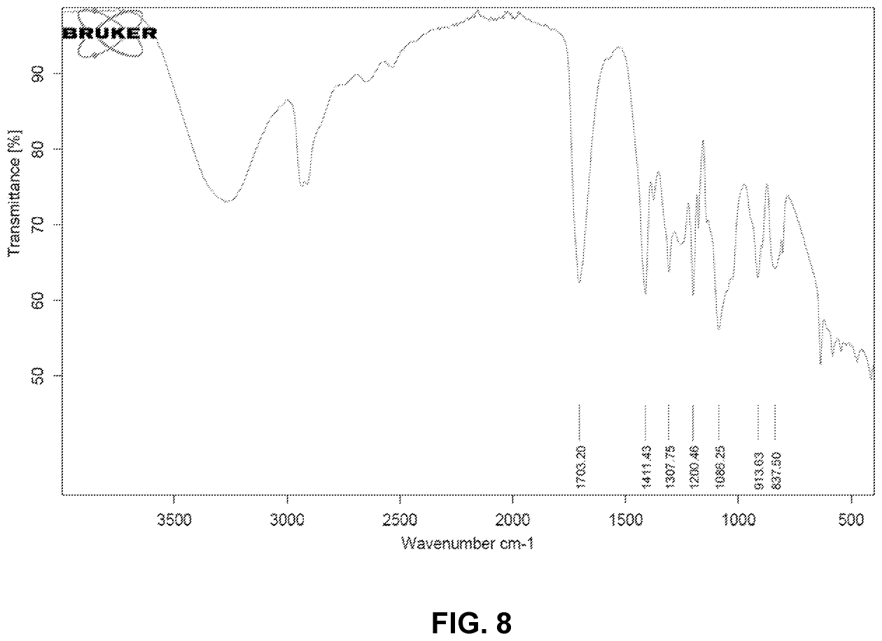

Infrared spectroscopy (IR) was used to evaluate vibrational frequencies produced by Suc1. An IR spectrum for Suc1 is provided in FIG. 8. A comparison of the IR spectrum of the unmodified PVOH-418 shown in FIG. 5 with the spectrum for Suc1 in FIG. 8 reveals a distinct change in the carbonyl stretching region in the range of 1600-1800 cm-1, which is consistent with introduction of moieties by reaction with succinic anhydride. More specifically, a shift is observed from about 1714 cm-1 for PVOH-418 to about 1703 cm-1 for Suc1. IR spectra were obtained using a Bruker Platinum spectrometer (neat, ATR sampling).

The Samples were then tested for disintegration in composting conditions, cold dispersibility/solubility, and hot dispersibility/solubility. The “Suc1” sample had thickness of about 35 microns, the “Suc3” sample had a thickness of about 76 microns, the Aquapak HWS sample had a thickness of about 35 microns, and the Aquapak WWS sample had a thickness of about 29 microns.

### Cold Water Dispersibility and Solubility

A cold water dispersibility test was performed by mixing at least 1 g (dry basis) of Suc1, HWS PVOH, and WWS PVOH films (having dimensions of at least 25 mm×25 mm) with 1 L of tap water under stirring conditions (magnetic stir rod) at 150 rpm in a 2 L beaker. The films were stirred for 16 hours at 25° C.±2° C. in the dark. After this period, the films were subjected to the determination of the water dispersible fraction (D) by sieving over a 10 mm sieve.

The tests were performed according to EN 14987 Plastics—Evaluation of disposability in waste water treatment plants—Test scheme for final acceptance and specifications (2006). Tests were performed in triplicate.

Table 2 shows the determination of cold water dispersibility (D) for the samples. In order to be considered cold water dispersible for purposes herein, at least 90% of the original material must pass through the 10 mm sieve. To be soluble, >90% of the material should go through a 0.45 μm filter. Table 2 also shows a pH at start and at the end of the test (16 hours). According to EN 14987 (2006) the initial pH should be neutral. The POxide sample was not tested.

TABLE 2

| | Dry | Dry | Cold Water | | | | pH after |
|---|---|---|---|---|---|---|---|
| | weight at | weight >10 | Dispersibility (%) | | | pH at | 16 hours |
| Sample | start (g) | mm (g) | Rep. | Avg | SD* | start | of stirring |
| Suc1 | 1.0667 | 0 | 100 | 100 | 0.0 | 7.9 | 8.0 |
| Suc1 | 1.0384 | 0 | 100 | | | 7.8 | 8.0 |
| Suc1 | 1.0256 | 0 | 100 | | | 7.8 | 7.9 |
| HWS PVOH | 1.0089 | 0.8564 | 15.1 | 15.2 | 0.1 | 8.0 | 8.5 |
| (comparative) | | | | | | | |
| HWS PVOH | 1.0041 | 0.8512 | 15.2 | | | 7.9 | 8.4 |
| (comparative) | | | | | | | |
| HWS PVOH | 1.0217 | 0.8648 | 15.4 | | | 8.0 | 8.4 |
| (comparative) | | | | | | | |
| WWS PVOH | 1.0297 | 0.0 | 100.0 | 100.0 | 0.0 | 8.1 | 8.4 |
| (comparative) | | | | | | | |
| WWS PVOH | 1.0361 | 0.0 | 100.0 | | | 8.1 | 8.5 |
| (comparative) | | | | | | | |
| WWS PVOH | 1.0139 | 0.0 | 100.0 | | | 8.0 | 8.5 |
| (comparative) | | | | | | | |

SD = standard deviation

At the end of the cold water dispersibility test (after 16 hours), a limpid solution was obtained for Suc1. After 16 hours of stirring (end of test), no significant change in pH was observed for Suc1. No pieces were retained on the 10 mm sieve, and the reactor contents were filtered directly through a 0.45 μm filter. The filtration over 0.45 μm proceeded very slowly, after approximately 3 hours only a few drops passed through the filter. The sample of Suc1 was determined to be cold water dispersible but not cold water soluble.

The solubility of HWS PVOH was not evaluated, as insufficient dispersibility was obtained. The reactor contents of test material WWS PVOH were filtered over 0.45 μm. The filtration proceeded very slowly, after several hours only a few drops passed through the filter. As such, the filtration was not possible, and the test material could not be defined as cold water soluble. From the results of this test, it can be concluded that HWS PVOH is not cold water dispersible, nor cold water soluble. Test material WWS PVOH is cold water dispersible but not cold water soluble. For both HWS PVOH and WWS PVOH materials, there was a slight increase in pH after 16 hours.

### Hot Water Dispersibility and Solubility

A hot water dispersibility test was performed by mixing at least 1 g (dry basis) of the films (having dimensions of at least 25 mm×25 mm) with 1 L of tap water under stirring conditions at 150 rpm in a 2 L beaker. The films were stirred for 16 hours at 60° C.±2° C. in the dark. After this period, the suspension was subjected to the determination of the water dispersible fraction (D) by sieving on a 10 mm screen. The total test was 16 hours and the test was performed in triplicate.

According to EN 14987 (2006), a material is considered to be hot water dispersible if it produces a dispersible fraction of ≥90% after dissolution in hot water. Further, according to EN 14987 (2006), the initial pH should be neutral. Table 3 shows the results of hot water dispersibility tests. Table 3 shows the amount of test material, after drying at 50° C., added to 1 L of tap water at the start and the amount of material that remained on the 10 mm sieve after stirring for 16 hours at 150 rpm at 60° C.

TABLE 3

| | Dry | Dry | Hot Water | | | | pH after |
|---|---|---|---|---|---|---|---|
| | weight at | weight >10 | Dispersibility (%) | | | pH at | 16 hours |
| Sample | start (g) | mm (g) | Rep. | Avg | SD | start | of stirring |
| Suc1 | 1.0709 | 0 | 100 | 100 | 0.0 | 8.6 | 8.2 |
| Suc1 | 1.0969 | 0 | 100 | | | 8.6 | 8.3 |
| Suc1 | 1.0921 | 0 | 100 | | | 8.6 | 8.2 |
| Suc3 | 1.0345 | 0 | 100 | 100 | 0 | 8.0 | 6.0 |
| Suc3 | 1.0264 | 0 | 100 | | | 8.1 | 6.4 |
| Suc3 | 1.0129 | 0 | 100 | | | 8.0 | 7.0 |
| HWS PVOH | 1.0225 | 0.7440 | 27.2 | 26.9 | 2.0 | 8.2 | 8.1 |
| (comparative) | | | | | | | |
| HWS PVOH | 1.0196 | 0.7670 | 24.8 | | | 8.3 | 8.3 |
| (comparative) | | | | | | | |
| HWS PVOH | 1.0185 | 0.7260 | 28.7 | | | 8.2 | 8.2 |
| (comparative) | | | | | | | |
| WWS PVOH | 1.0128 | 0.0 | 100.0 | 100.0 | 0.0 | 8.2 | 8.2 |
| (comparative) | | | | | | | |
| WWS PVOH | 1.0181 | 0.0 | 100.0 | | | 8.2 | 8.2 |
| (comparative) | | | | | | | |
| WWS PVOH | 1.0169 | 0.0 | 100.0 | | | 8.3 | 8.1 |
| (comparative) | | | | | | | |

SD = standard deviation

Hot water solubility was determined by filtration through a 0.45 μm filter. In order to be hot water soluble, a soluble fraction of ≥90% must be obtained after filtration through a 0.45 μm filter.

Films for Suc1 exhibited dispersibility and solubility at 60° C. At the end of the hot water dispersibility test (after 16 hours) a limpid solution was obtained for Suc1. A slight decrease in pH was measured at the end of the test (16 hours) in the reactors of Suc1, where the pH decreased from 8.6 to 8.2-8.3. No pieces were retained on the 10 mm sieve, therefore the reactor contents were filtered directly through a 0.45 μm filter. The filtration proceeded very fast and so it was possible to determine the solubility. Only 0.3% of the original weight was retained on the 0.45 μm filter, corresponding to a solubility of 99.7±0.1%. Suc1 fulfilled the dispersibility and solubility criteria as prescribed by EN 14987 (2006) and can be defined as hot water dispersible and soluble.

After sixteen hours, a limpid solution was obtained for Suc3. No pieces were retained on the 10 mm sieve. As no pieces were retrieved from the sieve for sample Suc3, 100% dispersibility was calculated. The reactor contents were filtered through a 0.45 micron filter. The filtration proceeded slowly. After more than one hour, only a few drops passed through the filter. As such, the Suc3 film could not be defined as hot water soluble. Therefore, the Suc3 film was characterized as hot water dispersible but not hot water soluble. The pH decreased significantly from 8.0-8.1 to values between 6.0 and 7.0.

The pieces of test HWS PVOH were rolled up but still mostly intact and were retained on the 10 mm sieve. The solubility of HWS PVOH was not evaluated, as insufficient dispersibility was obtained. The results in the table above show that 73.1% of the original weight of HWS PVOH was retained on the 10 mm sieve, corresponding to a dispersibility of 26.9%+2.0%. The pH remained quite stable over the 16-hour period.

As no pieces were retrieved from the sieve for WWS PVOH, 100.0% dispersibility was calculated. The reactor contents of WWS PVOH were filtered over 0.45 μm. The filtration proceeded very slowly, after several hours only a few drops passed through the filter. As such, the filtration was not possible and the test material could not be defined as hot water soluble. The pH remained quite stable over the 16 hour period.

From the results of this test, HWS PVOH was not hot water dispersible and was not hot water soluble. Test material WWS PVOH was hot water dispersible but not hot water soluble.

### Additional Solubility Testing

Testing of solubility in warm water (40° C.) was conducted on samples of films of Examples Suc1, Suc2, Suc3, and POxide. Pieces of films were added to water at 40° C. The results are presented in Table 4.

TABLE 4

| | | Maximum to | | Maximum to |
|---|---|---|---|---|
| | Average | minimum | Average | minimum |
| | disintegration | disintegration | dissolution | dissolution |
| Sample | time (s) | time (s) | time (s) | time (s) |
| Suc1 | 72 | 66-79 | 1151 | 716-1391 |
| Suc2 | 39 | 29-51 | 110 | 96-133 |
| Suc3 | 27 | 24-30 | 102 | 79-139 |
| POxide | 101 | 72-122 | 289 | 238-320 |

Films including the smallest and largest amounts of units produced by reaction between succinic anhydride and hydroxyl groups of a polyvinyl alcohol (Suc2 and Suc3) exhibited faster dissolution than the film including the intermediate amount of such units (Suc1).

All of the inventive examples showed rapid solubility, indicating that chemical modification of the PVOH polymer did not lead to loss of water solubility.

### Disintegration in Composting Conditions

The films were tested for soil-based disintegration by placement in compost. During home composting, high temperatures (>50° C.) obtained during industrial composting processes are mostly not reached. Therefore, a material should demonstrate sufficient disintegration at ambient temperature to be considered home compostable. The test set-up was based with some modifications, on the international standard ISO 20200 Plastics-Determination of the degree of disintegration of plastic materials under simulated composting conditions in a laboratory-scale test (2015).

The disintegration of the samples was qualitatively evaluated. The test lasted 16 weeks. The test materials were placed in slide frames, mixed with compost and incubated at 28° C.±2° C. in the dark. The test was performed in duplicate per test item. The compost consisted of a 80/20 mixture of <10 mm mature compost and fresh milled vegetable, garden, and fruit waste (VGF), respectively. The compost was regularly stirred and moistened, if needed. At the same time, the visual appearance of slide frames with test material was evaluated.

The mature compost was a mixture of mature VGF and green compost. The VGF compost was derived from the organic fraction of municipal solid waste and further stabilized and aerated in a pilot-scale composting bin at the laboratory under controlled conditions in order to obtain completely mature compost. The age of the VGF compost was 16 weeks. The green compost was derived from garden waste, prunings, tree roots and stumps, and was stabilized in a full-scale composting plant. The composts were mixed in a ratio of 50% VGF compost and 50% green compost. The mixture in the composting reactors was regularly turned manually during which the disintegration of the test samples was visually monitored.

The composting disintegration for a film of Suc1 (having a thickness of about 35 microns as measured with a digital micrometer) was evaluated. After 2 weeks, small holes started to appear in the test material of a few slide frames. It was noticed that the test material was very sticky. No significant progress in disintegration was observed during the following weeks. After 12 weeks of composting, small holes were noticed in the test material of some slide frames, while the test material in the major part of the slide frames remained intact. The disintegration slowly proceeded and after 16 weeks of compositing at ambient temperatures, small holes were present in the test material of the major part of the slide frames. However, the test material in a few slide frames remained completely intact. Based on the determination of the remaining surface of test material in slide frames, it was concluded that the test material is characterized by an average disintegration percentage of <81%.

The composting disintegration results for a Suc3 film (having a thickness of about 76 microns) were also evaluated. After 1 week of composting, the test material became brown and elastic. During the following weeks, no signs of disintegration were observed. After 20 weeks, the test material in all slide frames still remained completely intact. Two weeks later tiny holes started to appear in the test material of a few slide frames. After 26 weeks of composting, tiny holes were present in the test material of some slide frames while the test material in the major part of the slide frames remained completely intact. No further progress was noticed during the following weeks. After 32 weeks (the end of the test), tiny holes were observed in the test material of a few slide frames. However, the test material in the major part of the slides frames still remained completely intact. Based on the determination of the remaining surface of the test material in slides frames, it can be concluded that the test material Suc3 is characterized by a disintegration percentage of 0% after 32 weeks of composting at ambient temperature.

In comparison, two types of unmodified PVOH (Aquapak 30164P (hot water soluble; 35 microns) and Aquapak 33104P (warm water soluble; 29 microns) remained completely intact (0% disintegration) at 16 weeks. For HWS film samples (about 35 microns thick) and WWS film samples (about 29 microns thick), there were no signs of disintegration during the test. After 26 weeks, the test materials remained completely intact in all slide frames. The test materials were characterized by a disintegration percentage of 0% after 26 weeks of composting at ambient temperature.

The overall results for disintegration, cold dispersibility/solubility, and hot dispersibility/solubility are summarized in Table 5 below:

TABLE 5

| | | Cold | Cold | Hot | Hot |
|---|---|---|---|---|---|
| | Disintegration | dispers- | Solu- | dispers- | solu- |
| Sample | (composting) | ibility | bility | ibility | bility |
| Suc1 (~35 | <81% after 16 | Yes | No | Yes | Yes |
| microns) | weeks | | | | |
| Suc3 (~76 | 0% after 32 | Not | Not | Yes | No |
| microns) | weeks | tested | Tested | | |
| Aquapak | 0% after 26 | No | No | No | No |
| HWS (~35 | weeks | | | | |
| microns) | | | | | |
| Aquapak | 0% after 26 | Yes | No | Yes | No |
| WWS (~29 | weeks | | | | |
| microns) | | | | | |

### OTR and WVTR Testing

Oxygen transmission rates (OTR) and water vapor transmission rates (WVTR) were tested for films of Examples Suc1, Suc2, Suc3, and POxide. Oxygen transmission rate was measured at 23° C. and 0% relative humidity according to a test based on ASTM D3985 & ASTM F1927. The target oxygen transmission for the materials was <10 cc/m²/day. Water vapor transmission rate was measured at 38° C. and 90% relative humidity using a test based on ASTM F1249. The target water vapor transmission for the materials was less than 13.8 cc/m²/day at one week, or less than 6.57 cc/m²/day at two weeks.

Table 6 shows the OTR and WVTR exhibited by films of Examples Suc1, Suc2, Suc3, and POxide) as compared to conventional PVOH alone (comparative). The OTR results showed average performance by the four variables. When used as the only layer of a packaging film, the Suc1, Suc2, Suc3, and POxide samples had insufficient WVTR and OTR values for use in a sachet containing ketchup. The measured samples had an average gauge of 141 microns for the Suc1 sample, 42 microns for the Suc2 sample, 95 microns for the Suc3 sample, and 52 microns for the POxide sample.

TABLE 6

| Sample | OTR (cc/m²/day) | WVTR (cc/m²/day) |
|---|---|---|
| Suc1 | 22.2 | 433.1 |
| Suc2 | 21.7 | 525.4 |
| Suc3 | 29.9 | 696.6 |
| POxide | 18.0 | 875.8 |
| PVOH (comparative) | <0.008 | >100 |

Tensile strength and elongation, as well as puncture strength, were tested for films of Examples Suc1, Suc2, Suc3, and POxide as compared to unmodified PVOH. The target tensile strength and elongation was at least 50 N, and the target puncture strength was at least 20 N. Table 7 shows the tensile strength and elongation as well as puncture strength exhibited by films of Examples Suc1, Suc2, Suc3, and POxide. The tensile strength and puncture resistance were deemed satisfactory, while elasticity ranged from poor to good in the examples.

TABLE 7

| | Tensile Strength and | |
|---|---|---|
| Sample | Elongation | Puncture Strength |
| Suc1 | 77N and 63% | 108N |
| Suc2 | 196N and 12% | 91N |
| Suc3 | 60N and 36.6% | 84N |
| POxide | 100N and 22.5% | 55N |
| “HWS” PVOH | 50-80N | 20-40N |
| (comparative) | | |
| (hot water soluble | | |
| PVOH from Aquapak) | | |
| “WWS” PVOH | 50-80N | 20-40N |
| (comparative) | | |
| (warm water soluble | | |
| PVOH from Aquapak) | | |

Films of Examples Suc1, Suc2, Suc3, and POxide were used to form sealed sachets enclosing ketchup. The sachet formed from Suc1 burst when being filled with ketchup. The sachet formed from Suc2 could not be filled with ketchup due to the films being stuck together. The sachet formed from Suc3 exhibited a high percentage of loss of ketchup and shriveled 2 hours after filling. The sachet formed from POxide shriveled and drew all moisture out of the ketchup. Therefore, each of the Suc1, Suc2, Suc3, and POxide samples on their own would not be suitable for use in a single layer sachet but could be combined with other polymeric films or coatings to provide sachets that could be used for holding food products.

### Example 4—Modified Polyvinyl Polymer Including Units Produced by Reaction Between Succinic Anhydride and Hydroxyl Groups of a Polyvinyl Alcohol

### WWS-Suc

A polyvinyl alcohol solution was prepared by dissolving/suspending 30 g of PVOH-418 in 300 mL deionized water. The solution was placed in 500 mL Schott glass bottle including a 2 cm magnetic stir bar, which rested on an IKA hotplate with magnetic stirring. Next, 4 grams of solid succinic anhydride was added to the polyvinyl alcohol solution and the mixture was vigorously stirred at 80° C. for 5 hours. Two samples of the WWS-Suc polymer were tested for molecular weight using GPC having the following setup:

| Instrument | Viscotek GPC Max | |
|---|---|---|
| Columns | 2*30 cm Agilent OH60 GPC columns | |
| Eluent | Water + 0.2m sodium nitrate | |
| Flow rate | 1.0 | ml/min |
| Detection | RI | |
| Temperature | 40° | C. |

Samples were injected using automatic sample injection. Data capture and subsequent data analysis were carried out using Viscotek's ‘Omnisec’ software.

### HWS-Suc

A polyvinyl alcohol solution was prepared by dissolving/suspending 30 g of PVOH-E103 (a hot water soluble polyvinyl alcohol from Aquapak Polymers Ltd., Birmingham, UK) in 300 mL deionized water. The solution was placed in 500 mL Schott glass bottle including a 2 cm magnetic stir bar, which rested on an IKA hotplate with magnetic stirring. Next, 4 grams of solid succinic anhydride was added to the polyvinyl alcohol solution and the mixture was vigorously stirred at 80° C. for 5 hours. A sample of the HWS-Suc polymer was tested for molecular weight using the same equipment and procedure used to test two WWS-Suc samples.

Table 8 shows the molecular weight moments for the sample injections of the two WWS-Suc samples and the HWS-Suc sample.

TABLE 8

| Sample | Mw | Mn | Mw/Mn | Mz |
|---|---|---|---|---|
| WWS-Suc | 29,000 | 1,100 | 26.2 | 62,000 |
| WWS-Suc | 30,000 | 1,200 | 24.7 | 62,000 |
| HWS-Suc | 18,000 | 2,300 | 7.9 | 34,000 |

The matter set forth in the foregoing description and accompanying drawings is offered by way of illustration only and not as a limitation. While particular embodiments have been shown and described, it will be apparent to those skilled in the art that changes and modifications may be made without departing from the broader aspects of Applicant's contribution. The actual scope of the protection sought is intended to be defined in the following claims when viewed in their proper perspective based on the prior art.

1. A polymeric film comprising:
a modified polyvinyl polymer including a polyvinyl chain comprising one or more units including an ester moiety produced by reaction of an anhydride reactant with a hydroxyl group of a polyvinyl alcohol.

2. The polymeric film according to claim 1, wherein the anhydride reactant includes one or more of succinic anhydride, acetic anhydride, propionic anhydride, adipic anhydride, glutaric anhydride, pimelic anhydride, suberic anhydride, and malonic anhydride.

3. The polymeric film according to claim 1, wherein the one or more units including an ester moiety include a structure according to formula (II): 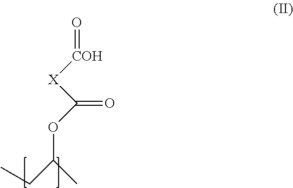
wherein X represents a divalent group.

4. The polymeric film according to claim 3, wherein the divalent group has 2 to 6 carbon atoms.

5. The polymeric film according to claim 1, wherein the one or more units including an ester moiety include a structure according to formula (III):

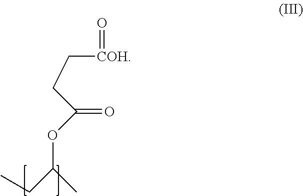

6. The polymeric film according to claim 1, wherein the polyvinyl chain of the modified polymer includes one or more crosslink units having a structure according to formula (IV): 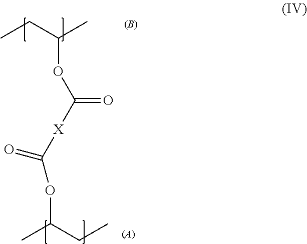
wherein X is a divalent group, the polyvinyl chain of the modified polyvinyl polymer includes unit (A) indicated with brackets, and
one of the following conditions is met for a crosslink unit of the one or more crosslink units:
the polyvinyl chain of the modified polyvinyl polymer includes unit (B) indicated with brackets, or
a polyvinyl chain of a separate polymer includes unit (B), and the polyvinyl chain of the separate polymer is derived from polyvinyl alcohol.

7. The polymeric film according to claim 6, wherein the divalent group X has 2 to 6 carbon atoms

8. The polymeric film according to claim 1, wherein the polyvinyl chain of the modified polymer includes one or more crosslink units having a structure according to formula (V): 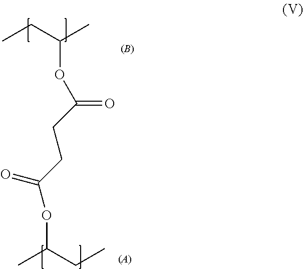
wherein the polyvinyl chain of the modified polyvinyl polymer includes unit (A) indicated with brackets, and
one of the following conditions is met for a crosslink unit of the one or more crosslink units:
the polyvinyl chain of the modified polyvinyl polymer includes unit (B) indicated with brackets, or
a polyvinyl chain of a separate polymer includes unit (B), and the polyvinyl chain of the separate polymer is derived from polyvinyl alcohol.

9. The polymeric film according to claim 1, wherein the polyvinyl chain further comprises one or more vinyl alcohol units having a structure according to formula (VIII):

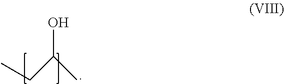

10. The polymeric film according to claim 1, wherein the polyvinyl chain further comprises one or more vinyl acetate units having a structure according to formula (IX):

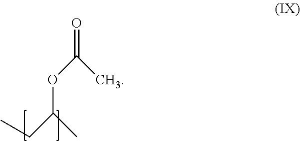

11. The polymeric film according to claim 1, wherein the polyvinyl chain further comprises one or more vinyl alcohol units having a structure according to formula (VIII): 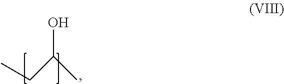
and
one or more vinyl acetate units having a structure according to formula (IX):

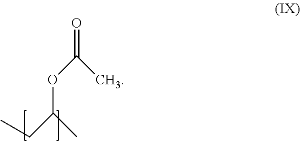

12-15. (canceled)

16. A food sachet comprising:
a sachet body including the polymeric film according to claim 1 and a second film, and
a food product enclosed in the sachet body.

17-20. (canceled)

21. The food sachet according to claim 16, wherein the food product comprises a condiment.

22-23. (canceled)

24. The food sachet according to claim 16, wherein the second film includes an unmodified polyvinyl alcohol polymer, the polymeric film contacting the food product enclosed in the sachet body, and the second film forming at least a part of an exterior of the sachet body.

25. A polymeric film comprising:
a modified polyvinyl polymer including a polyvinyl chain comprising one or more of:
a unit including an ester moiety produced by reaction of an anhydride reactant with a hydroxyl group of a polyvinyl alcohol, and
a unit including an ether moiety produced by reaction of an epoxide reactant with a hydroxyl group of a polyvinyl alcohol, the epoxide reactant having a structure according to formula (VI): 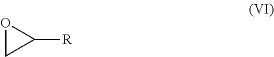
wherein R represents a monovalent group including 0 to 5 carbon atoms.

26. (canceled)

27. A method of making a modified polyvinyl polymer, the method comprising:
reacting a polyvinyl alcohol with an anhydride reactant in the presence of a solvent, wherein the anhydride reactant includes one or more of succinic anhydride, acetic anhydride, propionic anhydride, adipic anhydride, glutaric anhydride, pimelic anhydride, suberic anhydride, and malonic anhydride.

28-29. (canceled)

30. The method according to claim 27, wherein a mass ratio of the anhydride reactant to the polyvinyl alcohol ranges from 0.01:1 to 0.5:1.

31. The method according to claim 27, the method producing a modified polyvinyl polymer including a polyvinyl chain comprising one or more units including a structure according to formula (II): 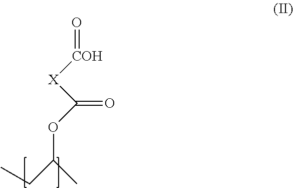
wherein X represents a divalent group.

32. The method according to claim 31, wherein the divalent group has 2 to 6 carbon atoms

33. The method according to claim 31, wherein the one more units include a structure according to formula (III):

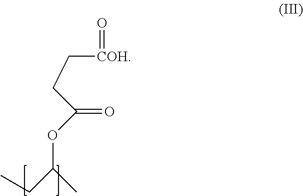

34. The method according to claim 31, the polyvinyl chain further comprising one or more vinyl alcohol units having a structure according to formula (VIII):

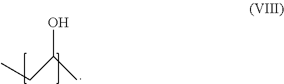

35. The method according to claim 31, the polyvinyl chain further comprising one or more vinyl acetate units having a structure according to following formula (IX):

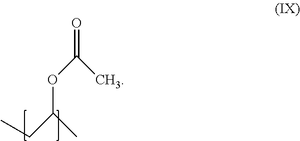

36. The method according to claim 31, the polyvinyl chain further comprising one or more vinyl alcohol units having a structure according to formula (VIII): 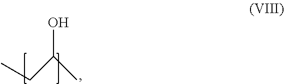
and
one or more vinyl acetate units having a structure according to formula (IX):

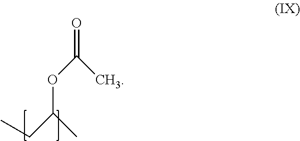

37-39. (canceled)
